(19) United States
(12) Patent Application Publication
(10) Pub. No.: US 2025/0322028 A1
(43) Pub. Date: Oct. 16, 2025

(54) COMPUTER-READABLE RECORDING MEDIUM HAVING STORED THEREIN PARAMETER IDENTIFICATION PROGRAM, PARAMETER IDENTIFICATION METHOD, AND INFORMATION PROCESSING APPARATUS

(71) Applicant: Fujitsu Limited, Kawasaki-shi (JP)

(72) Inventor: Nasa SONODA(MATSUMOTO), Kawasaki (JP)

(73) Assignee: Fujitsu Limited, Kawasaki-shi (JP)

(21) Appl. No.: 19/077,089

(22) Filed: Mar. 12, 2025

(30) Foreign Application Priority Data
Apr. 12, 2024 (JP) 2024-064913

(51) Int. Cl. G06F 17/11

(52) U.S. Cl. CPC G06F 17/11

(57) ABSTRACT

A computer-readable recording medium having stored therein a parameter identification program causes a computer to execute a process includes identifying one or more first parameters of a plurality of parameters used in an optimization algorithm, the one or more first parameters having a top degree of contribution to an optimization problem. The process incudes identifying respective one or more first values of the one or more first parameters while respective one or more values of one or more second parameters in the plurality of parameters are set to a given value, the one or more second parameters being different from the one or more first parameters. The process incudes identifying respective one or more second values of the one or more second parameters while one or more values of the one or more first parameters are set to the one or more first values.

### CROSS-REFERENCE TO RELATED APPLICATION

This application is based upon and claims the benefit of priority of the prior Japanese Patent application No. 2024-064913, filed on Apr. 12, 2024, the entire contents of which are incorporated herein by reference.

### FIELD

The present disclosure relates to a computer-readable recording medium having stored therein a parameter identification program, a parameter identification method, and an information processing apparatus.

### BACKGROUND

Optimization algorithms, such as Simulated Annealing (SA) and Tabu Search (TS), are known as solution approaches for optimization problems, such as combinatorial optimization problems.

In such optimization algorithms, tuning may be performed to appropriately set parameters (e.g., values to parameters), such as hyperparameters, when searching for the optimal solution. In such a tuning process, appropriate values are set to parameters for each problem (instance) for which the optimal solution is searched.

For example, related arts are disclosed in Japanese Laid-open Patent Publication No. 08-272761, Japanese Laid-open Patent Publication No. 2001-124667, US Patent Application Publication No. 2017/0161612, and US Patent Application Publication No. 2006/0036561.

### SUMMARY

According to an aspect of embodiment(s), a non-transitory computer-readable recording medium having stored therein a parameter identification program that causes a computer to execute the following process. The process may include identifying one or more first parameters of a plurality of parameters used in an optimization algorithm, the one or more first parameters having a top degree of contribution to an optimization problem. The process may also include identifying respective one or more first values of the one or more first parameters while respective one or more values of one or more second parameters in the plurality of parameters are set to a given value, the one or more second parameters different from the one or more first parameters. The process may further include identifying respective one or more second values of the one or more second parameters while one or more values of the one or more first parameters are set to the one or more first values.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a flowchart for explaining an approach for tuning parameters according to a comparative example;

FIG. 2 is a diagram illustrating one example of the relationship between the value of a parameter and the evaluation function value according to the degree of contribution;

FIG. 3 is a block diagram illustrating an example of the hardware configuration of a computer that embodies the functions of an optimization apparatus as one example of one embodiment;

FIG. 4 is a block diagram illustrating an example of the software configuration of the optimization apparatus according to one embodiment;

FIG. 5 is a diagram illustrating one example of an approach for selecting a parameter group A according to one embodiment;

FIG. 6 is a flowchart illustrating an example of the operation of the optimization apparatus according to one embodiment;

FIG. 7 is a diagram illustrating one example of the calculation of the degrees of contribution by a first approach;

FIG. 8 is a diagram illustrating examples of evaluation function values by the first approach;

FIG. 9 is a diagram illustrating one example of a range α and a range β;

FIG. 10 is a diagram illustrating an example of calculations of the range α and the range β; and

FIG. 11 is a diagram illustrating one example of tuning time by a second approach.

### DESCRIPTION OF EMBODIMENT(S)

Since tuning involves repeated trial searches to set appropriate parameters, it is time-consuming. Furthermore, when a plurality of parameters are present in the search for the optimal solution, it is challenging to simultaneously identify all these parameters. For example, when a plurality of parameters are interrelated, in other words, when it is not possible to set a plurality of parameters independently to each other, it becomes even more difficult to simultaneously identify all these parameters.

Hereinafter, an embodiment of the present disclosure will be described with reference to the drawings. However, the embodiment described below is merely exemplary, and it is not intended to exclude various modifications or applications of the techniques not explicitly described in the following. For example, various modifications can be made without departing from the scope thereof. In the drawings used in the following description, elements denoted by the like reference symbols denote the same or similar elements, unless otherwise stated.

### (A) Tuning of Parameters

First, the tuning of a plurality of parameters used in an optimization algorithm will be described.

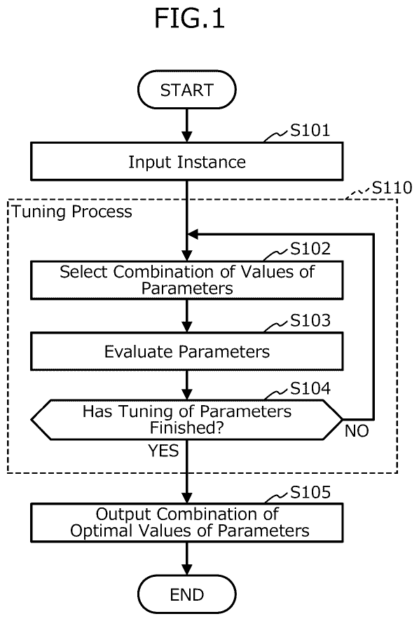

FIG. 1 is a flowchart for explaining an approach for tuning parameters according to a comparative example. In FIG. 1, one example of an approach is illustrated, wherein combinations of values of all parameters to be tuned are repeatedly selected to determine the optimal combination of the values of the parameters, as a tuning approach executed by an optimization apparatus that solves an optimization problem. The parameters are, for example, hyperparameters. Hereinafter, this approach is sometimes referred to as the “batch parameter tuning approach.”

In Step S101, an instance is input to the optimization apparatus. An instance is a specific example or case of a given problem in an optimization problem. Note that the batch parameter tuning approach is executed for each instance for which the optimal solution is to be searched. The optimization apparatus performs the parameter tuning process S110 (S102 to S104) for the input instance.

In Step S102, the optimization apparatus selects a value of each of parameters to be tuned from the candidates of values that can be set to the each parameter (the candidates of possible values of the each parameter). In other words, a combination of values of the parameters is selected.

In Step S103, the optimization apparatus sets the selected combination of values of the plurality of parameters and performs a solution process for the optimization problem for the instance. Based on the execution result, the values of the parameters are evaluated in the selected combination.

In Step S104, the optimization apparatus determines whether or not the tuning of the parameters has been finished. If the tuning has not been finished yet (NO in Step S104), the process proceeds to Step S102. If the tuning has been finished (YES in Step S104), the process proceeds to Step S105. The determination as to whether or not the tuning of the parameters has been finished may be made based on, for example, whether or not the evaluation result (an evaluation function value as one example) meeting the termination criteria is obtained in Step S103, or whether or not a given number of iterations has been performed, etc. The evaluation function value may refer to a value of the function to be optimized (evaluation function).

In Step S105, the optimization apparatus outputs the optimal combination of values of the parameters, e.g., the combination of values of the parameters that has yield the best result in the parameter evaluation, and the process is terminated.

In tuning approaches, it is important to find a more appropriate combination of values of parameters to improve the quality of the solution for enhancing the problem-solution performance of the optimization apparatus.

Here, the batch parameter tuning approach according to the comparative example illustrated in FIG. 1 performs the tuning of parameters under the assumption that the parameters are independent of each other.

However, in cases where the parameters are actually correlated, using the batch parameter tuning approach under this assumption may lead to the following situations with regard to the degree of contribution of a parameter and an evaluation function value. The evaluation function value may refer to a value of the function to be optimized (evaluation function). The degree of contribution of a parameter may refer to the magnitude of the change in the evaluation function value in response to the change in the value of the parameter.

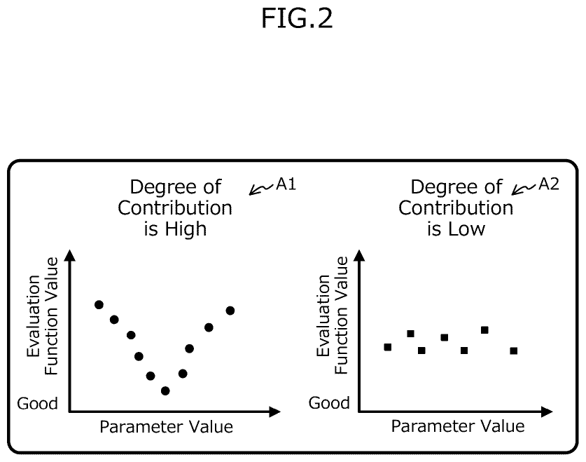

FIG. 2 is a diagram illustrating one example of the relationship between the value of a parameter and the evaluation function value according to the degree o contribution. In cases where parameters are actually correlated, a parameter with a high degree of contribution as indicated by the symbol A1 may correlate with a parameter with a low degree of contribution as indicated by the symbol A2, for example. This correlation may result in instability in the evaluation function values, such as degradation of the evaluation function values.

Or, for example, a parameter that consistently has a high degree of contribution to an instance for which the optimal solution is to be searched is correlated with a parameter of which the degree of contribution varies between instances, which may result in instability of the evaluation function values, such as degradation of the evaluation function values.

In this manner, when a plurality of parameters involved in the search for the optimal solution are interrelated, in other words, when it is difficult (e.g., not possible) to set a plurality of parameter values independently of each other, it may become challenging to determine all these parameter values simultaneously.

Therefore, in one embodiment, an approach for efficiently identifying the values of a plurality of parameters used in an optimization algorithm will be described.

### (B) Example of Configuration of Optimization Apparatus According to One Embodiment

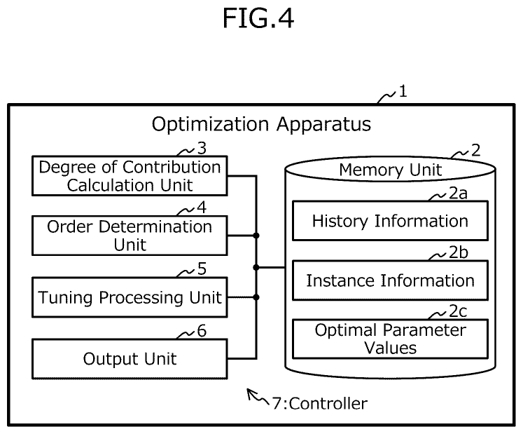

Hereinafter, an example of the configuration of an optimization apparatus 1 according to one embodiment (see FIG. 4) will be described.

### (B-1) Example of Hardware Configuration

The optimization apparatus 1 according to one embodiment may be a virtual server (virtual machine, VM) or a physical server. Furthermore, the functions of the optimization apparatus 1 may be embodied by a single computer or by two or more computers. Moreover, at least a part of the functions of the optimization apparatus 1 may be embodied using hardware (HW) resources and network (NW) resources provided by a cloud environment.

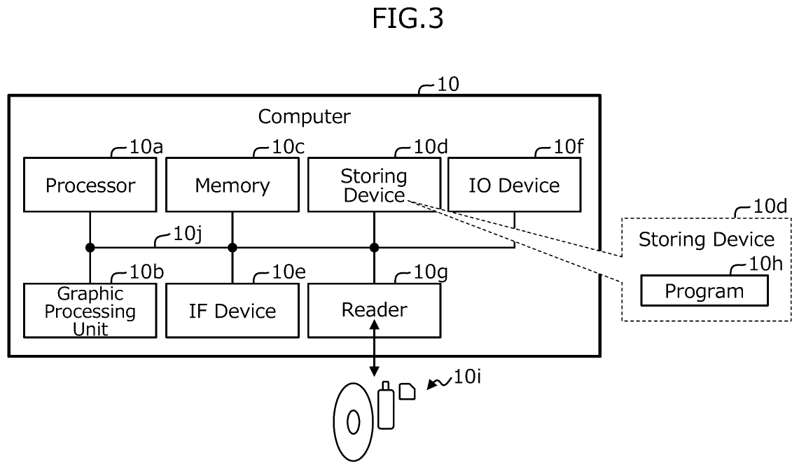

FIG. 3 is a block diagram illustrating an example of the hardware (HW) configuration of a computer 10 that embodies the functions of the optimization apparatus 1 as one example of one embodiment. When multiple computers are used as HW resources to embody the functions of the optimization apparatus 1, each computer may include the HW configuration illustrated in FIG. 3.

As illustrated in FIG. 3, the computer 10 may include, as an example, a processor 10a, a graphic processing unit 10b, a memory 10c, a storing device 10d, an interface (IF) device 10e, an input/output (IO) device 10f, and a reader 10g, as the HW configuration.

The processor 10a represents one example of a processing device that performs various control and computation operations. The processor 10a may be communicably connected to each block in the computer 10 via a bus 10j. The processor 10a may be a multiprocessor having a plurality of processors, may be a multicore processor having a plurality of processor cores, or may be configured to have a plurality of multicore processors.

Examples of the processor 10a include integrated circuits (ICs), such as a CPU, MPU, APU, DSP, ASIC, or FPGA, for example. Note that two or more combinations of these integrated circuits may be used for the processor 10a. CPU is an abbreviation for Central Processing Unit, and MPU is an abbreviation for Micro Processing Unit. APU is an abbreviation for Accelerated Processing Unit. DSP is an abbreviation for Digital Signal Processor, ASIC is an abbreviation for Application Specific IC, and FPGA is an abbreviation for Field-Programmable Gate Array.

The graphic processing unit 10b controls screen displays to an output device such as a monitor, which is a part of the IO unit 10f. Additionally, the graphic processing unit 10b may be configured as an accelerator that performs at least one of machine learning processes and inference processes using machine learning models. Examples of the graphic processing unit 10b include various arithmetic processing units, such as integrated circuits (ICs), e.g., a graphic processing unit (GPU), APU, DSP, ASIC, or FPGA.

The memory 10c and storing unit 10d each store information, such as various types of data and programs. Examples of the memory 10c include at least one of volatile memory, such as dynamic random access memory (DRAM), and non-volatile memory, such as persistent memory (PM), for example. Examples of the storing device 10d include various storing devices such as magnetic disk devices, e.g., a hard disk drive (HDD), semiconductor drive devices, e.g., a solid state drive (SSD), and non-volatile memory. Examples of non-volatile memory include flash memory, storage class memory (SCM), and read only memory (ROM), for example.

The storing device 10d may store a program 10h (parameter identification program) for embodying all or a part of the various functions of the computer 10. For example, the processor 10a of the optimization apparatus 1 may embody the functions of the controller 7 (see FIG. 4) described later by loading the program 10h stored in the storing unit 10d into the memory 10c and executing the program 10h.

The IF unit 10e represents one example of a communication IF that controls, etc. connections and communications between the optimization apparatus 1 and other computers. For example, the IF device 10e may include an adapter that is compliant with electronic communications, such as Ethernet® (e.g., a local area network (LAN)), or optical communications, such as Fibre Channel (FC), etc. This adapter may support either or both of wireless and wired communication methods. Note that the program 10h may be downloaded from a network to the computer 10 via the communication IF and stored in the storing device 10d.

The IO device 10f may include either or both of an input device and an output device. Examples of the input device include a keyboard, a mouse, and a touch panel, for example. Examples of the output device include a monitor, a projector, and a printer, for example. The IO device 10f may also include a touch panel that integrates an input device and an output device. The output device may be connected to the graphic processing unit 10b.

The reader 10g represents one example of a reader that reads information, such as data and programs recorded on a storage medium 101. The reader 10g may include a connection terminal or device to which the storage medium 10i can be connected or inserted. Examples of the reader 10g include adapters that are compliant with standards, such as Universal Serial Bus (USB), drive devices that access recording disks, and card readers that access flash memory, such as SD cards, for example. Note that the program 10h may be stored in the storage medium 10i, and the reader 10g may read the program 10h from the storage medium 10i and store the program 10h in the storing device 10d.

Examples of the storage medium 10i include, as an example, non-transitory computer-readable recording medium such as magnetic/optical disks and flash memory. Examples of the magnetic/optical disks include, as an example, flexible disks, compact discs (CDs), digital versatile discs (DVDs), Blu-ray discs, and holographic versatile discs (HVDs). Examples of the flash memory include semiconductor memory devices such as USB memory and SD cards.

The HW configuration of the computer 10 described above is exemplary. Accordingly, HW components may be added or deleted (any block may be added or deleted, for example), divided, integrated in any combination, or buses may be added or deleted, in the computer 10 as appropriate.

### (B-2) Example of Software Configuration

FIG. 4 is a block diagram illustrating an example of the software configuration of the optimization apparatus 1 according to one embodiment. The optimization apparatus 1 represents one example of a computer or an information processing apparatus and represents one example of a parameter identification apparatus that executes a parameter identification process to identify values of a plurality of parameters used in an optimization algorithm. Additionally, the optimization apparatus 1 may execute a solution process for an optimization problem, such as a combinatorial optimization problem, for an instance.

In the following description, the optimization apparatus 1 is assumed to execute a solution process for an optimization problem for an instance using parameters, e.g., hyperparameters, identified through a parameter identification process. However, this is not limiting. For example, the optimization apparatus 1 may also be an apparatus that executes only parameter identification processes among parameter identification processes and solution processes, and may output (provide) identified parameters to another optimization apparatus that executes solution processes.

As exemplified in FIG. 4, the optimization apparatus 1 includes a memory unit 2, a degree of contribution calculation unit 3, an order determination unit 4, a tuning processing unit 5, and an output unit 6. The degree of contribution calculation unit 3, the order determination unit 4, the tuning processing unit 5, and the output unit 6 represent one example of a controller 7. Note that the controller 7 may execute solution processes for optimization problems. The functions of the controller 7 may be embodied, for example, by the processor 10a in the computer 10 illustrated in FIG. 3 which executes the program 10h loaded into the memory 10c.

The memory unit 2 stores various data used for executing parameter identification processes by the optimization apparatus 1. For example, the memory unit 2 may store history information 2a, instance information 2b, and optimal parameter values 2c. The memory unit 2 may be embodied, for example, by storage areas in either or both of the memory 10c and storing unit 10d in the computer 10 illustrated in FIG. 3.

The history information 2a includes results in the past (experimental results), e. g., tuning results of parameters executed for a plurality of instances in the past. The history information 2a includes, for example, for each of a plurality of instances, a set (a pair) of values of a plurality of parameters (hyperparameters) (a combination of values of the parameters) identified for the each instance and evaluation function values obtained when the combination is set. Note that the plurality of instances may be instances that belong to a common field but may differ from each other in terms of the problems (optimization problems) and the solutions obtained by solving those problems. Examples of fields include, as one example, information technology (IT)-driven drug discovery.

The parameter tuning processes executed in the past stored in the history information 2a may employ the approach according to one embodiment or other approaches (e.g., the approach according to the comparative example), and these approaches may be employed in combination. Moreover, the history information 2a may be calculated by the optimization apparatus 1 or by other optimization apparatuses.

The instance information 2b is information about an instance for which the optimal solution is sought (to be searched), and is information indicating a specific example or case of a certain problem in an optimization problem, in other words, information indicating the conditions for the solution process for the optimization problem.

The optimization apparatus 1 (controller 7) may receive, for example, at least one of the history information 2a and the instance information 2b from another computer (not illustrated) via the IF unit 10e and a network and store the received information in a storage area.

The degree of contribution calculation unit 3 calculates the degree of contribution to changes in the evaluation function value for each parameter, based on the history information 2a. The degree of contribution represents one example of an indicator that indicates the extent to which changes in the value of a parameter contribute to changes in the evaluation function value.

The order determination unit 4 determines the order to tune a plurality of parameters based on the degrees of contribution calculated by the degree of contribution calculation unit 3.

For example, the order determination unit 4 selects a group A of one or more parameters (parameter group A) that consistently have high degrees of contribution to changes in the evaluation function value in a plurality of instances. The parameter group A represents one example of one or more first parameters of a plurality of parameters used in an optimization algorithm, the one or more first parameters having a top degree of contribution to an optimization problem (in an order of ranking of the degrees of contribution).

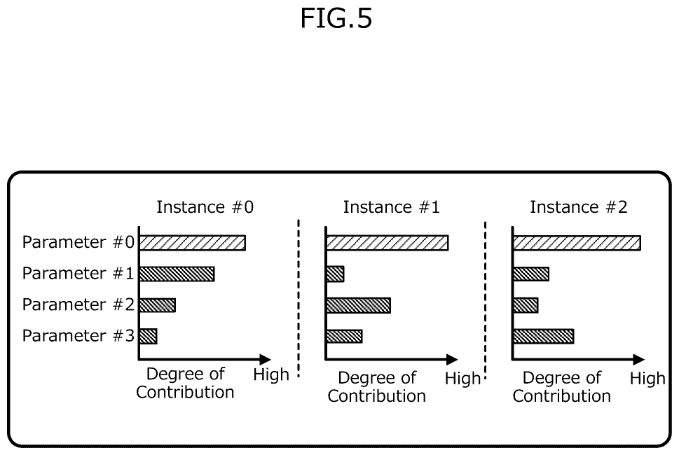

FIG. 5 is a diagram illustrating one example of an approach for selecting a parameter group A according to one embodiment. In FIG. 5, the degrees of contribution of parameters #0 to #3 are illustrated for each of instances #0 to #2. In the example illustrated in FIG. 5, the parameter #0 has most consistently high degrees of contribution in the instances #0, #1, and #2.

In this case, the order determination unit 4 selects the parameter #0 as the parameter group A. The order determination unit 4 may handle the remaining parameters other the parameter group A, i.e., the parameters #1, #2, and #3, as a group B of one or more parameters (parameter group B). The parameter group B represents one example of one or more second parameters of the plurality of parameters, the one or more second parameters being different from the one or more first parameters. The parameter groups A and B may each include one or more parameters.

The order determination unit 4 determines the parameter group A as a parameter to be tuned earlier (first), and the parameter group B as parameters to be tuned next (last). In this manner, the order determination unit 4 determines the order to tune (the order to set appropriate values to) the plurality of parameters.

The tuning processing unit 5 executes a tuning process of the plurality of parameters in a stepwise manner in accordance with the order determined by the order determination unit 4.

The tuning processing unit 5 identifies the value of each parameter in the parameter group A by executing tuning (tuning process A) of the parameter group A while setting a given value to each parameter (e.g., fixing the value of each parameter) in the parameter group B. The given value may be a default value, for example. The value of each parameter in the parameter group A represents one example of one or more first values.

For example, the tuning processing unit 5 selects the value of each parameter in the parameter group B set to the given value, and the value of each parameter in the parameter group A selected from candidates of value that can be set to the each parameter (candidates of possible values for the parameter) in the parameter group A, as a set of parameter values. The tuning processing unit 5 sets the values of the plurality of parameters according to the selected executes the solution process for the combination, optimization problem for the instance, and evaluates the parameters in the selected combination based on the execution result. The tuning processing unit 5 performs the solution process and evaluation of the parameters for all combinations obtained by changing the value of each parameter in the parameter group A, and completes the tuning process A.

Furthermore, the tuning processing unit 5 identifies the value of each parameter in the parameter group B by executing tuning (tuning process B) of the parameter group B while setting the identified value to each parameter in the parameter group A (e.g., fixing each parameter to the identified value). The value of each parameters in the parameter group B represents one example of one or more second values.

For example, the tuning processing unit 5 selects the value of each parameter in the parameter group A set to the identified value, and the value of each parameter in the parameter group B from candidates of value that can be set to the each parameter (candidates of possible values for the parameter) in the parameter group B, as a set of parameter values. The tuning processing unit 5 sets the values of the plurality of parameters according to the selected combination, executes the solution process for the optimization problem for the instance, and evaluates the parameters in the selected combination based on the execution result. The tuning processing unit 5 performs the solution process and evaluation of the parameters for all combinations obtained by changing the value of each parameter in the parameter group B, and completes the tuning process B.

Note that the tuning process performed by the tuning processing unit 5 may be similar to the process for evaluating parameters (Step S103) illustrated in FIG. 1, for example.

In this manner, the tuning processing unit 5 first tunes the identified parameter group A, and subsequently tunes the parameter group B, among the plurality of parameters to be tuned.

The output unit 6 outputs (stores) the identified value of each parameter in the parameter group A and the identified value of each parameter in the parameter group B as the optimal parameter values 2c to the memory unit 2. The optimal parameter values 2c are a combination of optimal values of the parameters and are, for example, used as setting values for hyperparameters when a solution process for an optimization problem is executed. Note that the output unit 6 may send the optimal parameter values 2c to other computers (not illustrated) via the IF unit 10e and a network.

### (C) Example of Operation in One Embodiment

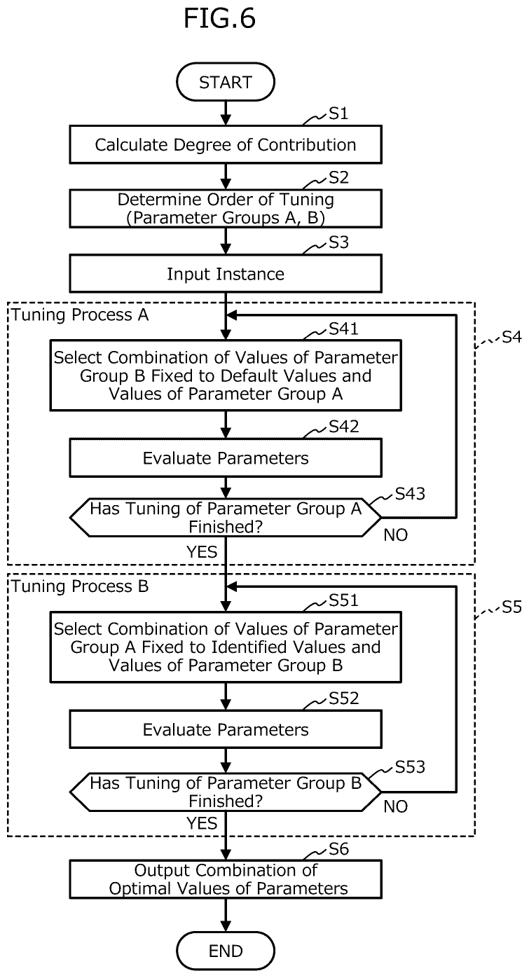

FIG. 6 is a flowchart illustrating an example of the operation of the optimization apparatus 1 according to one embodiment. It is assumed that the history information 2a and the instance information 2b have been stored in the memory unit 2.

In Step S1, the degree of contribution calculation unit 3 calculates the degrees of contribution of each of parameters based on the history information 2a.

In Step S2, the order determination unit 4 determines the order of tuning, e.g., the parameter groups A and B, based on the degrees s of contribution of each of parameters.

In Step S3, an instance is input from the instance information 2b to the tuning processing unit 5.

In Step S4 (S41 to S43), the tuning processing unit 5 executes a tuning process A for the parameter group A.

In Step S41, the tuning processing unit 5 selects one combination of values of parameters in the parameter group B fixed to the default value and values of parameters in the parameter group A.

In Step S42, the tuning processing unit 5 evaluates the parameters for the selected combination.

In Step S43, the tuning processing unit 5 determines whether or not the tuning for the parameter group A has been finished. If the tuning has not been finished yet (NO in Step S43), the process proceeds to Step S41. If the tuning has been finished (YES in Step S43), the process proceeds to Step S5. The determination as to whether or not the tuning of the parameters has been finished may be made based on, for example, whether or not the evaluation result (an evaluation function value as one example) meeting the completion criteria is obtained in Step S42, or whether or not a given number of iterations has been performed, etc.

After Step S4 is completed, in Step S5 (S51 to S53), the tuning processing unit 5 executes a tuning process B for the parameter group B.

In Step S51, the tuning processing unit 5 selects one combination of values of the parameters in the parameter group A fixed to the values identified in tuning process A and values of the parameters in the parameter group B.

In Step S52, the tuning processing unit 5 evaluates the parameters for the selected combination.

In Step S53, the tuning processing unit 5 determines whether or not to the tuning for the parameter group B has been finished. If the tuning has not been finished yet (NO in Step S53), the process proceeds to Step S51. If the tuning has been finished (YES in Step S53), the process proceeds to Step S6. The determination as to whether or not the tuning of the parameters has been finished may be made based on, for example, whether or not the evaluation result (an evaluation function value as one example) meeting the completion criteria is obtained in Step S52, or whether or not a given number of iterations has been performed, etc.

In Step S6, the output unit 6 outputs a combination of optimal values of the parameters identified by the tuning processing unit 5, e.g., a combination of values of the parameters that has yielded the best evaluation result in the evaluations of the parameters, as the optimal parameter values 2c, and the process ends. Note that the optimal parameter values 2c may be stored in the memory unit 2, for example.

As described above, according to the optimization apparatus 1 according to one embodiment, it is possible to identify appropriate values for a plurality of parameters, even in cases where two or more parameters of the plurality of parameters are interrelated to each other, for example. Additionally, since performing tuning for the parameter group A prior to the parameter group B reduces the variation in the degrees of contribution of the parameter group B between instances, good evaluation function values are obtained consistently and the quality of the solution is improved. In this manner, values of a plurality of parameters used in the optimization algorithm can be efficiently identified by the stepwise tuning approach.

### (D) Approaches for Embodying Degree of Contribution Calculation Process and Order Determination Process

Next, the approach for embodying the degree of contribution calculation process performed by the degree of contribution calculation unit 3 and the order determination process performed by the order determination unit 4 will be described with reference to two approaches, namely, a first approach and a second approach, as examples.

### (D-1) First Approach

The first approach involves using an evaluation algorithm for evaluating the degrees of contribution of parameters to calculate the respective degrees of contribution of the parameters, in the degree of contribution calculation process. In the following, a description will be made using the functional analysis of variance (fANOVA) as one example of such an evaluation algorithm. fANOVA is one type of variance analysis and an algorithm to evaluate the degrees of contribution of hyperparameters.

The degree of contribution calculation unit 3 may calculate the respective degrees of contribution of the parameters by executing a process based on the fANOVA algorithm, using the history information 2a as input data. For example, the degree of contribution calculation unit 3 may evaluate the degrees of contribution of the parameters using fANOVA through the following process.

The degree of contribution calculation unit 3 trains a machine learning model (hereinafter simply referred to as the “model”) that learns the relationship between values of a plurality of parameters and an evaluation function value obtained when these values are set to the parameters, using the history information 2a. A random forest may be used for training the model, for example.

Based on the trained model, the degree of contribution calculation unit 3 evaluates the degrees of contribution (degrees of importance) of the parameters to the evaluation function value. By employing fANOVA in this evaluation, the degree of contribution calculation unit 3 quantitatively evaluates the extent to which each parameter contributes to the evaluation function.

In the order determination process according to the first approach, the order determination unit 4 extracts one or more parameters having highest degrees of contribution in the order of the ranking of the degrees of contribution, for each instance. The order determination unit 4 then identifies one or more parameters that are frequently extracted among the extracted parameters in a plurality of instances, as parameters having consistently high degrees of contribution in the plurality of instances, in other words, selects them as the parameter group A.

For example, the order determination unit 4 extracts one or more top K parameters with high degrees of contribution for each instance. Then, the order determination unit 4 selects one or more top N parameters with high frequency of extraction as parameters with high degrees of contribution, as the parameter group A to be tuned first. K and N are each thresholds and are integers of 1 or more. The thresholds K and N may be determined based on the trends in the distribution of degrees of contribution in each instance. For example, if a parameter with a significantly high degree of contribution is present, K=1 and N=1, etc. are set.

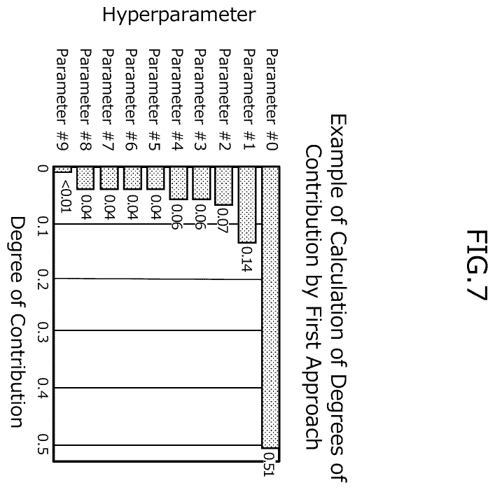

FIG. 7 is a diagram illustrating one example of the calculation of the degrees of contribution by the first approach. FIG. 7 depicts an example in which 10 types of hyperparameters are tuned for an optimization problem in IT-driven drug discovery. Tree-structured Parzen Estimator (TPE) was used as the algorithm for selecting a combination of parameters. In the experimental results (history information 2a) of 27 instances in the past, “Parameter #0” had the highest degrees of contribution in 23 instances. Thus, “Parameter #0” was selected as the parameter group A that consistently had a high degree of contribution.

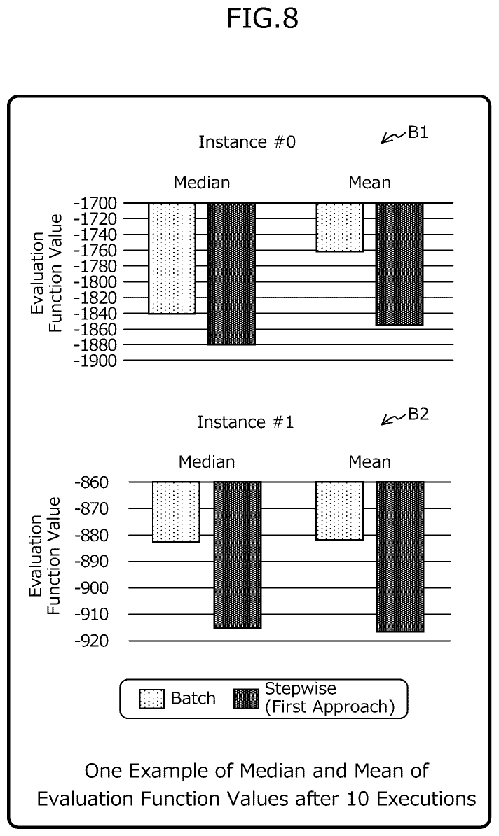

FIG. 8 is a diagram illustrating examples of evaluation function values by the first approach. FIG. 8 depicts the results of a comparison between the batch parameter tuning approach according the comparative example (denoted as “Batch” in FIG. 8) and the stepwise parameter tuning approach by the first approach (denoted as “Stepwise” in FIG. 8). In FIG. 8, the tuning for the parameter group A and the tuning for the parameter group B by the stepwise parameter tuning (the first approach) were each performed in about half the tuning time of the batch parameter tuning approach. In other words, the tuning time for the comparison example and the total tuning time for the first approach were assumed to be equivalent. In FIG. 8, the evaluation function values were calculated 10 times by setting the optimal combination of the values of parameters finally identified through tuning for both the comparison example and the: first approach, and the medians and means of the measurement results were calculated.

As illustrated in FIG. 8, in both the examples of Instance #0 (denoted by Symbol B1) and Instance #1 (denoted by Symbol B2), the medians and means of evaluation function values for the first approach were better than those of the comparative example, confirming the effectiveness of improving the quality of the solution.

Although the tuning times for the parameter group A and the parameter group B in the first approach were assumed to be equivalent in FIG. 8, greater effectiveness can be achieved by adjusting the ratio of tuning time between the parameter group A and the parameter group B. For example, the tuning processing unit 5 may reduce the ratio of the tuning time for the parameter group A relative to the total tuning time, according to the number of hyperparameters for identifying values. As one example, the tuning processing unit 5 may reduce the ratio of the tuning time for the parameter group A relative to the tuning time for the parameter group B as the number of hyperparameters for identifying values is decreased. If the optimal tuning times are determined for the parameter groups A and B in this manner, greater effectiveness can be expected in terms of both quality and time.

### (D-2) Second Approach

In the second approach, the possible range (first range) α of value of each parameter and the range (second range) β in which a good evaluation function value is obtained are defined for each instance, based on the history information 2a, and the ratio of the range β to the range α is calculated as the degree of contribution. Here, the “good evaluation function value” may be, for example, an evaluation function value equal to or greater than a given threshold. For example, the degree of contribution calculation unit 3 may identify the range β by finding parameter values that have yielded good solutions equal to or greater than the given threshold.

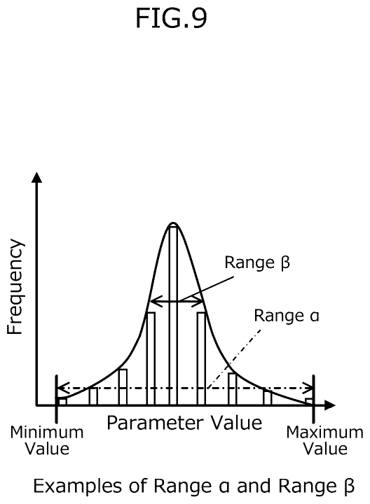

FIG. 9 is a diagram illustrating one example of the range α and the range β. In the second approach, the degree of contribution calculation unit 3 may calculate the value of β/α for each parameter in a graph (histogram) where the horizontal axis represents the values of the parameter and the vertical axis represents the frequency of the evaluation function value. The degree of contribution calculation unit 3 may determine the degree of contribution of each parameter such that the degree of contribution thereof is increased as the value of β/α is decreases.

For example, the degree of contribution calculation unit 3 normalizes the frequency distribution of each parameter for every instance in the past based on the history information 2a such that the minimum value is set to “0” and the maximum value to set to “1.” Subsequently, the degree of contribution calculation unit 3 fits the frequency distribution of parameter values that have yielded a good evaluation function value in a plurality of instances in the past to a normal distribution.

In this manner, the second approach selects the parameter group A based on the finding that a parameter with a steeper peak shape in the frequency distribution of parameter values substantially has a narrower range of possible values of the parameter and such a parameter tends to have a higher degree of contribution.

In the following, examples of calculations of the range α and the range β by the degree of contribution calculation unit 3 according to the condition of a parameter will be described. Note that the calculations (identifications) of the range α and the range β, as well as calculations of the degree of contribution based on the range α and the range β, are performed for each parameter to be analyzed.

### Example 1

When the minimum and maximum values of the parameter are not known in advance.

In this case, the degree of contribution calculation unit 3 fits the frequency distribution of parameter values obtained from tuning results of instances in the past to a normal distribution N₁, defines the mean of the normal distribution N₁ as μ₁, and defines standard deviation of the normal distribution N₁ as σ₁. The degree of contribution calculation unit 3 then defines the range “μ₁±6σ₁” as the range α and normalizes the frequency distribution such that the minimum value is “0” and the maximum value is “1.” Subsequently, the degree of contribution calculation unit 3 fits the frequency distribution of parameter values that have yielded good evaluation function values in the instances in the past to a normal distribution N₂, and defines the mean of the normal distribution N₂ as μ₂, and defines standard deviation of the normal distribution N₂ as σ₂. The degree of contribution calculation unit 3 then defines the range “μ₂±σ₂” as the range β.

### Example 2

When the minimum and maximum values of are known in advance, and the frequency a parameter distribution of parameter values obtained from tuning results of instances in the past is not biased toward either the minimum or maximum value.

In this case, the degree of contribution calculation unit 3 defines the range from the minimum value to the maximum value of the parameter as the range α and normalizes the frequency distribution such that the minimum value is “0” and the maximum value is “1,” as exemplified in FIG. 9. Subsequently, the degree of contribution calculation unit 3 fits the frequency distribution of parameter values that have yielded good evaluation function values in the instances in the past to a normal distribution N₂, and defines the mean of the normal distribution N₂ as μ₂, and defines standard deviation of the normal distribution N₂ as σ₂. The degree of contribution calculation unit 3 then defines the range “μ₂±σ₂” as the range β.

### Example 3

When the minimum and maximum values of a parameter are known in advance, and the frequency distribution of parameter values obtained from tuning results of instances in the past is biased toward either the minimum or maximum value.

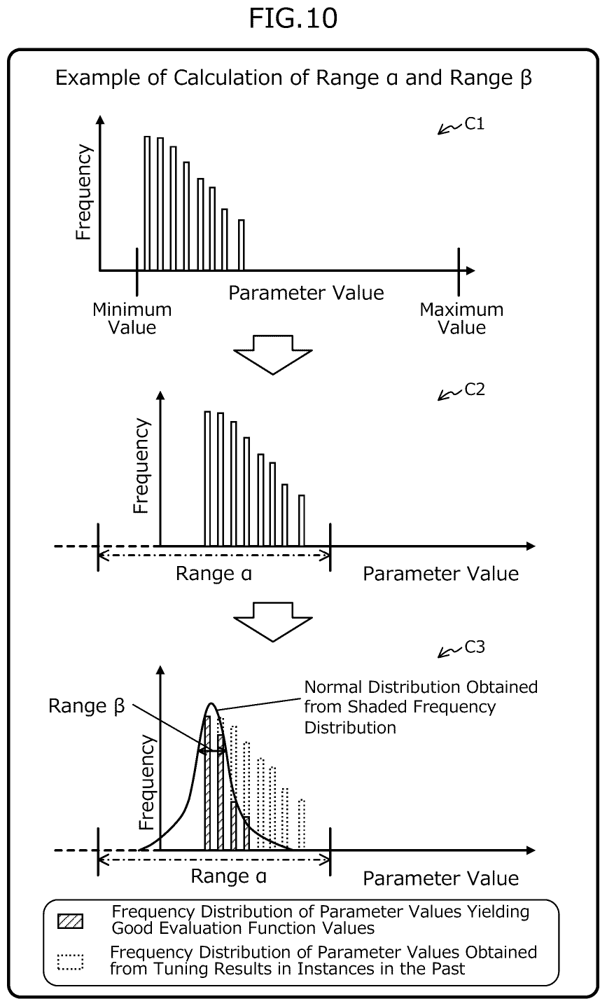

FIG. 10 is a diagram illustrating an example of calculations of the range α and the range β. In FIG. 10, the symbol C1 denotes an example where the frequency distribution of parameter values is biased toward the minimum value. As indicated by the symbol C2, the degree of contribution calculation unit 3 expands the range toward the biased side, fits the frequency distribution to the normal distribution N₁, and defines the mean of the normal distribution N₁ as μ₁, and defines standard deviation of the normal distribution N₁ as σ₁. The degree of contribution calculation unit 3 then defines the range “μ₁±3σ₁” as the range α and normalizes the frequency distribution such that the minimum value is “0” and the maximum value is “1.” In this manner, the range α, i.e., the range “μ₁±3σ₁,” as indicated by the symbol C2, is obtained from the frequency distribution indicated by the symbol C1. Subsequently, as indicated by the symbol C3, the degree of contribution calculation unit 3 fits the frequency distribution of parameter values that have yielded good evaluation function values in the instances in the past with a normal distribution N₂, and defines the mean of the normal distribution N₂ as μ₂, and defines standard deviation of the normal distribution N₂ as σ₂. In the graph of the symbol C3, the shaded (hatched) area of the histogram is the frequency distribution of values where good solutions with evaluation function values equal to or greater than a given threshold were yielded, and the solid line graph is the normal distribution N₂ derived from this shaded area. From this normal distribution, the range β (μ₂±σ₂) is identified.

The degree of contribution calculation unit 3 defines the ratio β/α of the size of the range β to the size of the range α identified using the above approach, as the degree of contribution, where a smaller β/α ratio indicates a higher degree of contribution. In the above example, since the size of the range α is normalized to 1 and the size of the range β is 2σ₂, β/α=β=2σ₂. In other words, the degree of contribution calculation unit 3 may define β, which is twice the standard deviation ν₂ of the normal distribution N₂, as the degree of contribution, where a smaller standard deviation σ₂ indicates a higher degree of contribution.

In the order determination process according to the second approach, the order determination unit 4 extracts, for each instance, one or more, e.g., the top K, parameters with highest degrees of contribution in the order of the ranking of the degrees of contribution. The order determination unit 4 calculates the variance of the means μ₂ in a plurality of instances based on the mean μ₂ in the normal distribution N₂ fitted by the degree of contribution calculation unit 3 for each extracted parameter.

The order determination unit 4 then identifies parameters with small variances in the means μ₂ among the extracted parameters with high degrees of contribution, as parameters that consistently have high degrees of contribution in the plurality of instances, or in other words, as the parameter group A. For example, the order determination unit 4 identifies one or more, e.g., the top N, parameters with smallest variances of the means μ₂ among the extracted parameters with high degrees of contribution, as the parameter group A. The thresholds K and N are similar to those described in the first approach.

As described above, the second approach can also achieve effects similar to (for example, equivalent to) those of the first approach.

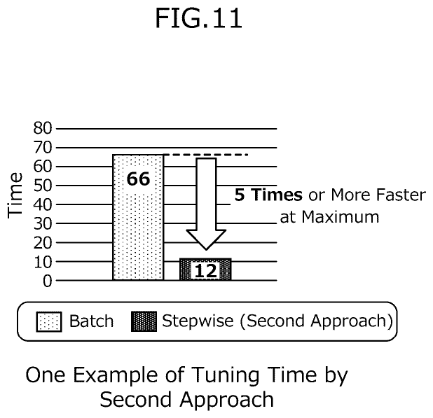

FIG. 11 is a diagram illustrating one example of tuning time by the second approach. FIG. 11 depicts the results of the comparison of the processing time between the batch parameter tuning approach according to the comparative example (denoted as “Batch” in FIG. 11) and the stepwise parameter tuning approach by the second approach (denoted as

“Stepwise” in FIG. 11). As illustrated in FIG. 11, according to the second approach, evaluation function values equivalent to those of the comparative example can be obtained in tuning time that is five times or more faster at maximum (one-fifth or less the time). This demonstrates the effectiveness of reducing tuning time through improved quality of the solution.

### (E) Miscellaneous

The technology according to one embodiment described above may be modified or changed as follows.

For example, the degree of contribution calculation unit 3, the order determination unit 4, the tuning processing unit 5, and the output unit 6 provided in the optimization apparatus 1 illustrated in FIG. 4 may be combined in any combination or divided as needed.

Additionally, in one embodiment, an example in which a plurality of parameters are divided into the parameter group A and the parameter group B and tuning is performed in two stages has been described as the stepwise parameter tuning approach. However, this is not limiting. For example, the optimization apparatus 1 may select a parameter group B1 including parameters with consistently high degrees of contribution in a plurality of instances, from a plurality of parameters included in the parameter group B. In this case, the optimization apparatus 1 may execute three-stage tuning in the order of the parameter group A, the parameter group B1, and the parameter group B2. By further dividing the remaining parameter group (e.g., the parameter group B2), tuning in four or more stages is also possible.

Furthermore, the known evaluation algorithm used to evaluate the degrees of contribution of parameters in the first approach is not limited to fANOVA, and various other evaluation algorithms may also be employed. For example, evaluation algorithms, such as the permutation feature importance (PFI) and partial dependence plot (PDP), may be used.

PFI is an evaluation algorithm that evaluates the degrees of contribution (degrees of importance) of features (hyperparameters) by randomly sorting values of the features and calculating the extent to which the prediction accuracy of the machine learning model decreases. By using PFI, it is possible to know (determine) the extent to which each feature contributes to the evaluation function.

PDP is an evaluation algorithm that visually displays the extent to which a prediction by a machine learning model changes when the value of a certain feature (hyperparameter) is varied, thereby evaluating the influence of that feature. By using PDP, it is possible to know (determine) how each feature influences the evaluation function.

Additionally, for example, the optimization apparatus 1 illustrated in FIG. 4 may have a configuration in which multiple apparatuses cooperate with each other via a network to embody each processing function. As one example, the degree of contribution calculation unit 3, the order determination unit 4, the tuning processing unit 5, and the output unit 6 may be embodied by an application server or a web server, while the memory unit 2 may be embodied by a database (DB) server. In this case, the web server, the application server, and the DB server may cooperate with each other via a network to embody processing functions as the optimization apparatus 1.

In one aspect, values of a plurality of parameters to be used in an optimization algorithm can be identified efficiently.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein a parameter identification program that causes a computer to execute a process comprising:
identifying one or more first parameters of a plurality of parameters used in an optimization algorithm, the one or more first parameters having a top degree of contribution to an optimization problem;
identifying respective one or more first values of the one or more first parameters while respective one or more values of one or more second parameters in the plurality of parameters are set to a given value, the one or more second parameters being different from the one or more first parameters; and
identifying respective one or more second values of the one or more second parameters while one or more values of the one or more first parameters are set to the one or more first values.

2. The non-transitory computer-readable recording medium according to claim 1,
wherein the identifying the one or more first parameters comprises
calculating respective degrees of contribution of the plurality of parameters using an evaluation algorithm for evaluating degrees of contribution of parameters.

3. The non-transitory computer-readable recording medium according to claim 1,
wherein the identifying the one or more first parameters comprises
calculating, for each of the plurality of parameters, a ratio of a second range in which an evaluation function value equal to or greater than a given threshold is obtained, to a first range of possible values for the parameter, as the degree of contribution of the parameter, based on a combination of values of the plurality of parameters and an evaluation function value obtained when the combination is set, the combination and the evaluation function value being previously identified for each of a plurality of instances.

4. The non-transitory computer-readable recording medium according to claim 3,
wherein the identifying the one or more first parameters comprises:
extracting, for each instance, from the plurality of parameters, one or more parameters having a highest calculated degree of contribution in an order of ranking of calculated degrees of contribution;
calculating a variance of means of the degree of contributions for each of the one or more extracted parameters, in the plurality of instances; and
identifying, as the one or more first parameters, from the extracted parameters, one or more parameters having smallest variances in an order of ranking of calculated variances.

5. The non-transitory computer-readable recording medium according to claim 1, the process comprising
outputting a combination of the one or more first values of the one or more first parameters and the one or more second values of the one or more second parameters, as setting values of hyperparameters to be set in a solution process for the optimization problem.

6. A computer-implemented parameter identification method that causes a computer to execute a process comprising:
identifying one or more first parameters of a plurality of parameters used in an optimization algorithm, the one or more first parameters having a top degree of contribution to an optimization problem;
identifying respective one or more first values of the one or more first parameters while respective one or more values of one or more second parameters in the plurality of parameters are set to a given value, the one or more second parameters being different from the one or more first parameters; and
identifying respective one or more second values of the one or more second parameters while one or more values of the one or more first parameters are set to the one or more first values.

7. The computer-implemented parameter identification method according to claim 6,
wherein the identifying the one or more first parameters comprises
calculating respective degrees of contribution of the plurality of parameters using an evaluation algorithm for evaluating degrees of contribution of parameters.

8. The computer-implemented parameter identification method according to claim 6,
wherein the identifying the one or more first parameters comprises
calculating, for each of the plurality of parameters, a ratio of a second range in which an evaluation function value equal to or greater than a given threshold is obtained, to a first range of possible values for the parameter, as the degree of contribution of the parameter, based on a combination of values of the plurality of parameters and an evaluation function value obtained when the combination is set, the combination and the evaluation function value being previously identified for each of a plurality of instances.

9. The computer-implemented parameter identification method according to claim 8,
wherein the identifying the one or more first parameters comprises:
extracting, for each instance, from the plurality of parameters, one or more parameters having a highest calculated degree of contribution in an order of ranking of calculated degrees of contribution;
calculating a variance of means of the degree of contributions for each of the one or more extracted parameters, in the plurality of instances; and
identifying, as the one or more first parameters, from the extracted parameters, one or more parameters having smallest variances in an order of ranking of calculated variances.

10. The computer-implemented parameter identification method according to claim 6, the process comprising
outputting a combination of the one or more first values of the one or more first parameters and the one or more second values of the one or more second parameters, as setting values of hyperparameters to be set in a solution process for the optimization problem.

11. An information processing apparatus comprising:
a memory; and
a processor coupled to the memory, the processor being configured to perform a process comprising
identifying one or more first parameters of a plurality of parameters used in an optimization algorithm, the one or more first parameters having a top degree of contribution to an optimization problem,
identifying respective one or more first values of the one or more first parameters while respective one or more values of one or more second parameters in the plurality of parameters are set to a given value, the one or more second the one or more first parameters being different from parameters, and
identifying respective one or more second values of the one or more second parameters while one or more values of the one or more first parameters are set to the one or more first values.

12. The information processing apparatus according to claim 11,
wherein, in the specifying the one or more first parameters, the processor
calculates respective degrees of contribution of the plurality of parameters using an evaluation algorithm for evaluating degrees of contribution of parameters.

13. The information processing apparatus according to claim 11,
wherein, in the specifying the one or more first parameters, the processor
calculates, for each of the plurality of parameters, a ratio of a second range in which an evaluation function value equal to or greater than a given threshold is obtained, to a first range of possible values for the parameter, as the degree of contribution of the parameter, based on a combination of values of the plurality of parameters and an evaluation function value obtained when the combination is set, the combination and the evaluation function value being previously identified for each of a plurality of instances.

14. The information processing apparatus according to claim 13,
wherein, in the specifying the one or more first parameters, the processor
extracts, for each instance, from the plurality of parameters, one or more parameters having a highest calculated degree of contribution in an order of ranking of calculated degrees of contribution,
calculates a variance of means of the degree of contributions for each of the one or more extracted parameters, in the plurality of instances, and
identifies, as the one or more first parameters, from the extracted parameters, one or more parameters having smallest variances in an order of ranking of calculated variances.

15. The information processing apparatus according to claim 11,
wherein, in the process, the processor
outputs a combination of the one or more first values of the one or more first parameters and the one or more second values of the one or more second parameters, as setting values of hyperparameters to be set in a solution process for the optimization problem.
